(19) United States
(12) Patent Application Publication
(10) Pub. No.: US 2026/0205889 A1
(43) Pub. Date: Jul. 16, 2026

(54) USER EQUIPMENT, BASE STATION, COMMUNICATION NETWORK NODE, AND METHOD

(71) Applicant: Sony Group Corporation, Tokyo (JP)

(72) Inventors: Hideji WAKABAYASHI, Basingstoke (GB); Yuxin WEI, Basingstoke (GB); Yassin Aden AWAD, Basingstoke (GB); Vivek SHARMA, Basingstoke (GB)

(73) Assignee: Sony Group Corporation, Tokyo (JP)

(21) Appl. No.: 19/135,811

(22) PCT Filed: Dec. 20, 2023
(86) PCT No.: PCT/EP2023/087045

§ 371 Date: Jun. 5, 2025

(30) Foreign Application Priority Data
Dec. 23, 2022 (EP) 22216650.6

(51) Int. Cl. H04W 28/24; H04W 8/22; H04W 76/10

(52) U.S. Cl. CPC H04W 28/24; H04W 8/22; H04W 76/10

(57) ABSTRACT

The present disclosure generally pertains to user equipment including circuitry configured to: establish a radio bearer based on a signaling from a core network or based on assistance information from an application function, wherein the radio bearer meets a time-sensitive stream requirement.

### TECHNICAL FIELD

The present disclosure generally pertains to a user equipment, a base station, a communication network node, and a method for operating a 5G network in an industrial environment.

### TECHNICAL BACKGROUND

In 3GPP IoT (Internet of Things) Rel-16 and Rel-17, functions for industrial internet of things (IIoT) are introduced. These releases were made for supporting industry 4.0, factory automation, smart cities, and the like.

One feature of these releases is time sensitive communication (TSC), which may enable to handle a highly accurate time synchronization between devices, low latency traffic and highly reliable communication.

According to 3GPP, TSC should be compatible with the wired based time sensitive network (TSN). However, IIoT covers a wide variety of applications and the requirements are quite different from the conventional 3GPP applications such as voice, text, web browsing, and so on. Although there exist techniques for providing a network configuration for an IIoT, it is generally desirable to provide a user equipment (or user equipment (UE)), a base station, a communication network node, and a method.

### SUMMARY

According to a first aspect, the disclosure provides a user equipment comprising circuitry configured to:
establish a radio bearer based on a signaling from a core network or based on assistance information from an application function, wherein the radio bearer meets a time-sensitive stream requirement.

According to a second aspect, the disclosure provides a method carried out in a user equipment, the method comprising:
establishing a radio bearer based on a signaling from a core network or based on assistance information from an application function, wherein the radio bearer meets a time-sensitive stream requirement.

According to a third aspect, the disclosure provides a mobile telecommunications system base station comprising circuitry configured to:
establish a radio bearer based on a signaling from a core network or based on assistance information from an application function, wherein the radio bearer meets a time-sensitive stream requirement.

According to a fourth aspect, the disclosure provides a method carried out in a mobile telecommunications system base station, the method comprising:
establishing a radio bearer based on a signaling from a core network or based on assistance information from an application function, wherein the radio bearer meets a time-sensitive stream requirement.

According to a fifth aspect, the disclosure provides a user equipment comprising circuitry configured to:
carry out an emergency stop based on a quality of service flow.

According to a sixth aspect, the disclosure provides a method carried out in a user equipment, the method comprising:
carrying out an emergency stop based on a quality of service flow.

According to a seventh aspect, the disclosure provides a mobile telecommunications base station comprising circuitry configured to:
provide a quality of service flow to a user equipment for surveilling functionality of the user equipment and, in case of the quality of service flow does not meet a requirement, for carrying out an emergency stop of the user equipment.

According to an eighth aspect, the disclosure provides a method carried out in a mobile telecommunications base station, the method comprising:
providing a quality of service flow to a user equipment for surveilling functionality of the user equipment and, in case of the quality of service flow does not meet a requirement, for carrying out an emergency stop of the user equipment.

According to a ninth aspect, the disclosure provides a user equipment comprising circuitry configured to:
receive a request for assistance information; and
send the assistance information when a trigger condition is met.

According to a tenth aspect, the disclosure provides a method carried out in a user equipment, the method comprising:
receiving a request for assistance information; and
sending the assistance information when a trigger condition is met.

According to an eleventh aspect, the disclosure provides a mobile telecommunications base station comprising circuitry configured to:
request, to a user equipment, assistance information which is provided to the base station when a trigger condition is met.

According to a twelfth aspect, the disclosure provides a method carried out in a mobile telecommunications base station, the method comprising:
requesting, to a user equipment, assistance information which is provided to the base station when a trigger condition is met.

According to a thirteenth aspect, the disclosure provides a communication network node comprising circuitry configured to:
obtain time-sensitive communication assistance information, TSCAI, from a user equipment, wherein the TSCAI is generated by the user equipment.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 shows a configuration of a TSN stream in a 5G network;

FIG. 2 shows a TSN system;

FIG. 3 shows a method for configuring a TSN-AF by a CUC;

FIG. 4 depicts a method showing information exchange between the TSN-AF, core network, and RAN;

FIG. 5 depicts an IIoT system according to the present disclosure;

FIG. 6 depicts a method according to the present disclosure for transmitting TSCAI;

FIG. 7 depicts a further method according to the present disclosure for transmitting TSCAI based on a trigger condition; and

FIG. 8 depicts a further method according to the present disclosure for transmitting TSCAI from a UE to a TSN-AF.

### DETAILED DESCRIPTION OF EMBODIMENTS

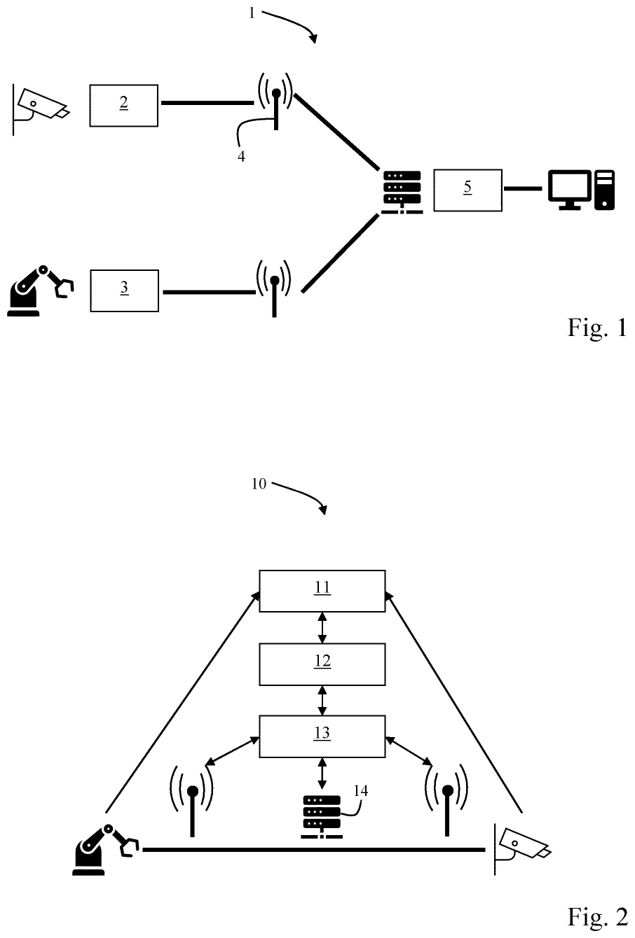

Before a detailed description of the embodiments starting with FIG. 1 is given, general explanations are made.

In the present disclosure, the following definitions are used:

Configured Grant (CG): See patent application publication WO 2022/029112 A1: Configured Grant UCI Multiplexing on PUSCH Repetitions

Semi-persistence scheduling (SPS): See patent application publication WO 2022/152433 A1: HARQ-ACK bundling for different SPS instances in an SPS Group

Time sensitive network (TSN): See WO 2021/209235 A1 Grand Master Clock UE (DS-TT) providing uplink synchronizations for TSN

Application function (AF): An application function is an interface between TSN CNC and 5G (see below)

The following definitions are in accordance with IoT white paper, as retrieved from [1]:

TSN Solution Components: There may be five main components in TSN (time-sensitive network):

TSN flow: Term used to describe time-critical communication between end devices. Each flow has strict time requirements that the networking devices honor. Each TSN flow is uniquely identified by the network devices.

End device: Source and destination of TSN flow. The end device may run an application that may requires deterministic communication. End devices are also referred to as talkers and listeners.

Bridges: Also referred to as Ethernet switches. For TSN, these are special bridges capable of transmitting the Ethernet frames of a TSN flow on a schedule and receiving Ethernet frames of a TSN flow according to a schedule.

Central network controller (CNC): For TSN, the CNC acts as a proxy for the Network (the TSN Bridges and their interconnections) and the control applications that require deterministic communication. The CNC defines the schedule on which all TSN frames are transmitted. The CNC application is provided by the vendor of the TSN bridges.

Centralized user configuration (CUC): An application that communicates with the CNC and the end devices. The CUC represents the control applications and the end devices. The CUC makes requests to the CNC for deterministic communication (TSN flows) with specific requirements for those flows. The CUC is an application that is vendor specific. Typically, the vendor of the TSN end devices will supply a CUC for those end devices.

The following definition of TSC (time-sensitive communication) assistance information TSCAI) is in accordance with 3GPP IoT Release 17. The TSCAI is used for describing TSC traffic characteristics for IIoT application. The RAN (e.g., the gNB) may use it to decide efficient scheduling strategies, resource allocation, and the like. For example, it may be used to configure semi-persistent scheduling (SPS), configure grant (CG), and the like.

The TSCAI may include the following parameters:

Flow direction: Direction of TSC flow (uplink or downlink)

Periodicity: Time-period between start of two bursts

Burst arrival time: Latest possible time when first packet of data burst arrives at either the ingress of RAN (radio access network) (downlink flow direction) or egress interface of a user equipment (UE) (uplink flow direction)

Survival time: As defined in 3GPP TS 22.261 (Service requirements for 5G systems); refers to a time period an application can survive without any bursts

In factory, plant control, the wired based communication networks which may be used may be referred to as Fieldbus.

Fieldbus may refer to a name of a family of industrial computer networks used for real-time distributed control. Fieldbus profiles are standardized by the International Electrotechnical Commission (IEC) as IEC 61784/61158.

A complex automated industrial system is typically structured in hierarchical levels as a distributed control system (DCS). In this hierarchy the upper levels for production managements are linked to the direct control level of programmable logic controllers (PLC) via a non-time-critical communications system (e.g. Ethernet). The fieldbus links the PLCs of the direct control level to the components in the plant of the field level such as sensors, actuators, electric motors, console lights, switches, valves and contactors and replaces the direct connections via current loops or digital I/O signals. The requirement for a fieldbus are therefore time-critical and cost sensitive. Since the new millennium a number of fieldbuses based on Real-time Ethernet have been established. These have the potential to replace traditional fieldbuses in the long term.

The following definition is obtained from 3GPP TS 23.501 V 17.5.0 (2022-06):

The 5G System architecture includes the following network functions (NF):
Authentication Server Function (AUSF).
Access and Mobility Management Function (AMF).
Data Network (DN), e.g. operator services, Internet access or 3rd party services.
Unstructured Data Storage Function (UDSF).
Network Exposure Function (NEF).
Network Repository Function (NRF).
Network Slice Admission Control Function (NSACF).
Network Slice-specific and SNPN Authentication and Authorization Function (NSSAAF).
Network Slice Selection Function (NSSF).
Policy Control Function (PCF).
Session Management Function (SMF).
Unified Data Management (UDM).
Unified Data Repository (UDR).
User Plane Function (UPF).
UE radio Capability Management Function (UCMF).
Application Function (AF).
User Equipment (UE).
(Radio) Access Network ((R)AN).
5G-Equipment Identity Register (5G-EIR).
Network Data Analytics Function (NWDAF).
CHarging Function (CHF).
Time Sensitive Networking AF (TSN AF).
Time Sensitive Communication and Time Synchronization Function (TSCTSF).
Data Collection Coordination Function (DCCF).
Analytics Data Repository Function (ADRF).
Messaging Framework Adaptor Function (MFAF).
Non-Seamless WLAN Offload Function (NSWOF).

NOTE: The functionalities provided by DCCF and/or ADRF can also be hosted by an NWDAF.
Edge Application Server Discovery Function (EASDF).

The 5G System architecture also comprises the following network entities:
Service Communication Proxy (SCP).
Security Edge Protection Proxy (SEPP).

The functional descriptions of these Network Functions and entities are specified in clause 6.
Non-3GPP InterWorking Function (N3IWF).
Trusted Non-3GPP Gateway Function (TNGF).
Wireline Access Gateway Function (W-AGF).
Trusted WLAN Interworking Function (TWIF).

It has been recognized that internet of things (IOT) and industrial internet of things (IIoT) applications may be different from conventional cellular application, e.g., in the context of 5G.

For example, IIoT may need to support various network topologies, such as start, ring, daisy chain (line), mesh, mixtures thereof, or the like.

In conventional cellular applications, a typical topology may be start topology (e.g., one base station sending to multiple terminal devices or user equipments (UE)), but in industrial communication, such as a factory floor, the topology may depend on a layout of a machine, requirements of communications, or the like.

Moreover, if wired communication is replaced with 5G wireless communication, it should (ideally) meet the requirements of wired communications. For example, the ring topology communication or mesh topology communication may be used if high reliable of the communication between the network devices is required, because such topologies may be able to communicate even if one of the links is deactivated. It has been recognized that it may be desirable that, in 5G, the same reliability requirements but with alternative technology may need to be met.

It has further been recognized that various type of communication may need to be supported.

In conventional industrial communication, there may be many communication modes/types because there may be many standards/products to meet the communication requirements for various industries, such as periodic/aperiodic, synchronous/asynchronous, deterministic/non-deterministic, cyclic/event driven/, realtime/non-realtime/isochronous, or the like.

It has been recognized that 5G TSN may need to be able to connect to them and/or replace wire-based solutions with wireless ones.

In the following, definitions of different communication types are given.

### Cyclic/Event Driven

In cyclic communication, the terminal devices (also referred to as user equipment (UE)) may be get information after one another. For example, UE A→UE B→UE C→UE D, then back to start, UE A. Time slots may be pre-allocated and guaranteed to use for the specific UE. For example, transmission may be based on time division, but also other transmission types may be envisaged. For example, resources may be separated in a frequency domain or in a special domain (e.g. beam domain) if transmissions overlap in a same time slot.

On the other hand, event driven is traffic may be handled when an event (e.g., an alarm) occurs, such that such communication may be referred to as “on-demand”. However, if low latency is required, such as for a critical alarm, the traffic may need to be handled immediately. Depending on the type of event/alarm, different strategies of traffic handling may be required. Even for delay tolerant events, a time stamp when an event occurs should be accurate because a historical log may be useful for trouble shooting.

### Deterministic/non-Deterministic

In deterministic communication, uncertainty/randomness may be removed as much as possible. The factors of uncertainty may be avoided, such as a collision of resource usage (e.g. contention, interferences), effect of channel fading (error), shortage of transmission power in an amplifier, network node overload beyond the capacity, and the like. Deterministic communication may be provided by a combination of multiple technologies. For example, the cyclic communication or periodic resource allocation may be used to provide deterministic communication.

### Synchronous/Asynchronous

Asynchronous communication may have a different meaning depending on the context. In conventional LPWA (low power wide area) IoT (delay tolerant system), a receiver may use the signal later after a UE sends the signal. The time when the data received may be much later than the time when the data is used.

In industrial IoT, such as factory automation, an unexpected, unplanned alarm may be raised. Such an alarm may be considered as asynchronous. However, urgency may depend on a type of event/alarm. Some events may be delay tolerant, but some events should be handled immediately.

In industrial IoT, both synchronous and asynchronous traffic may need to be handled.

### Realtime/non-Realtime/Isochronous

In 3GPP context, realtime traffic may be used for voice, video, and the like. The realtime traffic may need to be handled within an allowed delay (e.g., for voice, latency may need to be less than 100 ms). Therefore, such traffic may be handled like voice over LTE (VoLTE). On the other hand, non-real time traffic may not require such handling.

It has been recognized that, in IIoT, a further traffic class may be needed which may be called “isochronous”. Isochronous communication may provide low latency communication, very accurate time synchronization, and high reliability. It may be suitable for industrial application like motion control. The 5G TSN may be a key technology to meet this requirement.

### Periodic/Aperiodic

In periodic communication, a signal may be transmitted in regular interval. For example, a UE may repeatedly transmit a signal every 5 ms, or the like.

As indicated above, in industrial communication, there may be various combination of the different communication types, which should also be usable in 5G. More information may be obtained from the white paper [2].

However, it has been recognized that no 3GPP standard defines how these different communication types should be taken into account by the TSN.

Moreover, it has been recognized that various types of use cases may be present in factory automation, which should still be usable in 5G IIoT. Such use cases may be shown in 3GPP TR 22.804 V 16.3.0 (2020-07). In the following, some use cases are defined.

### Motion Control

In a factory, a motor/actuator may control objects to move to a predetermined position, with a predetermined speed, at a predetermined timing (e.g., conveyor belt, robots). This may be achieved based on sensors.

It has been recognized that such a system may have a feedback loop to adjust position/speed and it may require low latency, very accurate time synchronization and high reliability. It should be based on deterministic communication and may use cyclic communication to guarantee a quality of service (QoS).

### Alarm/Event

Alarm/events may occur at unexpected times. However, there may be various types of alarms/events. For example, an immediate action may be required for an alarm which shows an emergency situation. On the other hand, some events may be delay tolerant and as a first step, it may be sufficient to just record it in a log. However, in a conventional 3GPP, such diversity of events is not taken into account.

In addition, a very accurate time stamp may be required for events because a time series analysis may help with trouble-shooting.

### Non-Realtime Data

In a factory, a machine may be controlled by a computer (system), e.g., based on ERP (enterprise resource planning), MES (manufacturing execution system), SCADA (supervisory control and data acquisition). Large volumes of data may be trafficked, but such systems may need to be delay tolerant. In a factory environment, the real-time communication and non-realtime one may be mixing.

### Machine Vision

Video analytics and/or image processing may require handling of large volumes of data. A sensing result may need to be used for motion control (e.g., robot vision). In machine vision, eMBB type traffic and URLLC type traffic may be mixed in a system.

### Safety Communication

It has been recognized that for factory automation with 5G, it may be challenging to support safety control functions such as “emergency stop switch”, “Deadman's switch”, or the like, which may be designed to stop a machine if the human operator cannot operate it for some reason (e.g., loss of consciousness).

Hence, even if the communication does not work properly, a safety communication function may need to work to prevent an accident.

Returning to FIG. 1, there is shown a configuration of a TSN stream in a 5G system 1.

Similar to a bearer in 3GPP, there is a concept of TSN stream which offers the data stream between TSN end-devices. Depending on the traffic QoS class, more than one stream (i.e., separate TSN stream) may be configured.

The TSN stream(s) between UPF 5 (NW-TT) and UEs 2 and 3 (DS-TT) is (are) established via gNodeB(s) 4. The stream uses QoS flow(s) in a core network and Data Radio Bearer (DRB) in a RAN. Moreover, an external master clock (e.g., GNSS) is used to maintain the accurate time synchronization in 5G system.

An overall TSN system 10 in terms of configuration is shown in FIG. 2.

A centralized user configuration (CUC) 11 collects the TSN requirements from end devices/applications 2 and 3 of the TSN 10. The CUC 11 prepares the requirement of network configuration per TSN stream and provides it to centralized network controller (CNC) 12.

In a conventional (wire-based) TSN, the CNC 12 may configure the network nodes for the TSN stream(s) in line with CUC TSN stream request.

However, in this embodiment for 5G TSN, CNC 12 does not directly configure the 5G network. It provides the request for 5G system to a TSN application function (TSN-AF) 13, which works as an interface between the 3GPP system and the (external) TSN components 11 and 12. The TSN-AF 13 requests to configure the core network 14. In addition, it provides assistance information to a RAN to optimize RAN resources/scheduling in line with the TSN stream.

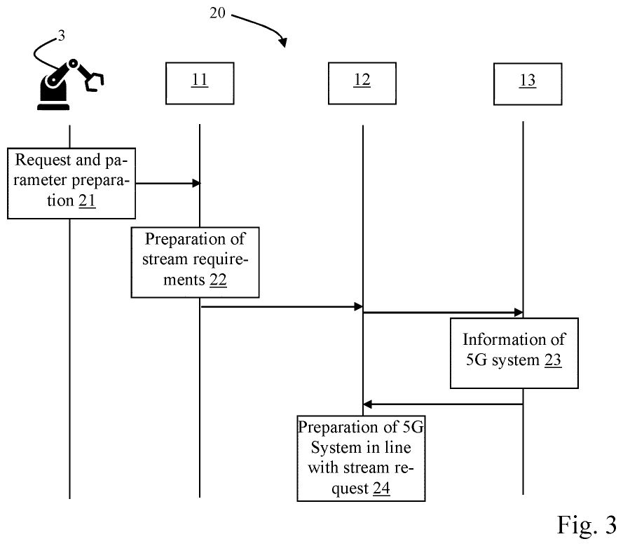

A method 20 for configuring the TSN-AF 13 by the CUC 11 is shown under reference of FIG. 3.

At 21, the end device 3 sends parameters for a TSN stream to the CUC 11.

At 22, the CUC 11 prepares stream requirements and transmits them to the CNC 12. The preparation of the stream requirements includes an interpretation of the request from the end device 3.

Moreover, the CUC 11 sends the request to the TSN-AF 13, which, at 23, sends initial information on 5G TSN back to the CNC 12. Note that the UE 3 may have more than one DS-TT function, one UPF may have more than one NW-TT function.

Hence, at 23, the TSN-AF 13 informs the 5G system (i.e., the core network 14) of the stream.

Such information includes DS-TT (UE side) and NW-TT (UPF side), port number and port address, possible network topology (e.g., redundancy path), time synchronization (e.g., 5G grand master clock, TSN time domain), and network capability (e.g., supported QoS).

In turn, at 24, the CNC 12 prepares the 5G system in line with the stream requirements. Hence, the CNC 12 prepares the network configuration/resources to meet the TSN stream request, such as network topology configuration (e.g., redundancy path) and QoS of TSN stream. Moreover, scheduling and/or resources reservation for the stream is carried out by the CNC 12.

Moreover, the CNC 12 may send the TSN request to the TSN-AF 13 with an application interface (API).

However, it has been recognized that the application layer protocol which requests the stream is not defined in 3GPP papers. It is merely defined that the end device sends the TSN stream request to the CUC 11 based on a 5G user plane if it has registered to 5G.

However, it has been recognized that it is desirable to provide a protocol which takes the above considerations into account.

Therefore, some embodiments pertain to a user equipment including circuitry configured to: establish a radio bearer (e.g., DRB, as discussed herein) based on a signaling from a core network or based on assistance information from an application function, wherein the radio bearer meets a time-sensitive stream requirement.

In some embodiments, the circuitry is further configured to: request the time-sensitive stream based on at least one of an operation and maintenance tool, a service contract, and a predefined configuration of the user equipment.

For example, based on the operation and maintenance (O&M) tool, the communication structure (e.g., ring, mesh, or the like), may be input.

For example, a service contract with a telecom operator, information in a home subscriber server (HSS), unified data management (UDM), or the like may include UE capabilities and/or expected service level, such that this information may be taken into account while establishing the stream.

For example, a predefined configuration (e.g., in a SIM card, information in application, or the like), may be taken into account when establishing the stream.

Hence, in some embodiments, the request based on the service contract is further based on information in at least one of a home subscriber server and a unified data management entity, as discussed herein.

In some embodiments, the request is further based on at least one of capabilities of the user equipment and an expected service level, as discussed herein.

In some embodiments, the predefined configuration is based on at least one of a SIM configuration and an application, as discussed herein.

In some embodiments, the request indicates at least one TSN stream requirement.

In some embodiments, the at least one time-sensitive stream requirement indicates at least one of a characteristic of the time-sensitive stream, a traffic quality of service, a system requirement, a capability of the user equipment, and a feature of the user equipment.

In some embodiments, the characteristic of the time-sensitive stream includes at least one of a type of the user equipment, a type of traffic, a purpose of the time-sensitive stream, and a type of a traffic pattern.

In some embodiments, the type of the user equipment includes at least one of a programmable logic controller, a pressure sensor, a human machine interface, and an emergency switch.

In some embodiments, at least one of the type of traffic and the purpose of the time-sensitive stream include at least one of safety communication, motion control, realtime data transfer, and non-realtime data transfer.

In some embodiments, the type of traffic pattern includes at least one of cyclic, periodic, aperiodic, synchronous, asynchronous, deterministic, and non-deterministic, as discussed herein.

In some embodiments, the traffic quality of service includes at least one of a time-related requirement, a data rate requirement, a quality requirement, and monitoring requirement.

In some embodiments, the time-related requirement includes at least one of an end-to-end latency, a maximum allowed delay in worst case, time synchronicity, and cycle time.

In some embodiments, the data rate requirement includes at least one of a required bandwidth, a required communication rate, and a data rate.

In some embodiments, the quality requirement includes at least one of an error rate, a priority, and a service continuity.

In some embodiments, the monitoring requirement includes at least one of an error rate and a latency.

In some embodiments, the system requirement includes at least one of availability, security, a virtual isolation capability.

In some embodiments, at least one of the capability and the feature of the user equipment include at least one of supported band, supported frequency, RAT, non-RAT, 3GPP feature, non-public network support, public network support, mobility of the user equipment, supported positioning feature, power supply status, and authentication.

In some embodiments, the circuitry is further configured to: communicate with a centralized user configuration entity, as discussed herein.

In some embodiments, the circuitry is further configured to: send, to the centralized user configuration entity, at least one of characteristics of the time-sensitive stream, system requirements, and a capability of the user equipment.

In some embodiments, the user equipment is part of an industrial 5G network, as discussed herein.

In some embodiments, the industrial 5G network is provided in accordance with 3GPP IoT release 16 or later, as discussed herein.

In some embodiments, the time-sensitive stream corresponds to an internet of things data stream.

Some embodiments pertain to a method carried out in a user equipment, the method including: establishing a radio bearer based on a signaling from a core network or based on assistance information from an application function, wherein the radio bearer meets a time-sensitive stream requirement, as discussed herein.

In some embodiments, the method further includes: requesting a time-sensitive stream based on at least one of an operation and maintenance tool, a service contract, and a predefined configuration of the user equipment, as discussed herein. In some embodiments, the request based on the service contract is further based on information in at least one of a home subscriber server and a unified data management entity, as discussed herein. In some embodiments, the request is further based on at least one of capabilities of the user equipment and an expected service level, as discussed herein. In some embodiments, the predefined configuration is based on at least one of a SIM configuration and an application, as discussed herein. In some embodiments, the request indicates at least one time-sensitive stream requirement, as discussed herein. In some embodiments, the at least one time-sensitive stream requirement indicates at least one of a characteristic of the time-sensitive stream, a traffic quality of service, a system requirement, a capability of the user equipment, and a feature of the user equipment, as discussed herein. In some embodiments, the characteristic of the time-sensitive stream includes at least one of a type of the user equipment, a type of traffic, a purpose of the time-sensitive stream, and a type of a traffic pattern, as discussed herein. In some embodiments, the type of the user equipment includes at least one of a programmable logic controller, a pressure sensor, a human machine interface, and an emergency switch, as discussed herein. In some embodiments, at least one of the type of traffic and the purpose of the time-sensitive stream include at least one of safety communication, motion control, realtime data transfer, and non-realtime data transfer, as discussed herein. In some embodiments, the type of traffic pattern includes at least one of cyclic, periodic, aperiodic, synchronous, asynchronous, deterministic, and non-deterministic, as discussed herein. In some embodiments, the traffic quality of service includes at least one of a time-related requirement, a data rate requirement, a quality requirement, and monitoring requirement, as discussed herein. In some embodiments, the time-related requirement includes at least one of an end-to-end latency, a maximum allowed delay in worst case, time synchronicity, and cycle time, as discussed herein. In some embodiments, the data rate requirement includes at least one of a required bandwidth, a required communication rate, and a data rate, as discussed herein. In some embodiments, the quality requirement includes at least one of an error rate, a priority, and a service continuity, as discussed herein. In some embodiments, the monitoring requirement includes at least one of an error rate and a latency, as discussed herein. In some embodiments, the system requirement includes at least one of availability, security, a virtual isolation capability, as discussed herein. In some embodiments, at least one of the capability and the feature of the user equipment include at least one of supported band, supported frequency, RAT, non-RAT, 3GPP feature, non-public network support, public network support, mobility of the user equipment, supported positioning feature, power supply status, and authentication, as discussed herein. In some embodiments, the method further includes: communicating with a centralized user configuration entity, as discussed herein. In some embodiments, the method further includes: sending, to the centralized user configuration entity, at least one of characteristics of the time-sensitive stream, system requirements, and a capability of the user equipment, as discussed herein. In some embodiments, the user equipment is part of an industrial 5G network, as discussed herein. In some embodiments, the industrial 5G network is provided in accordance with 3GPP IoT release 16 or later, as discussed herein. In some embodiments, the time-sensitive stream corresponds to an internet of things data stream, as discussed herein.

Some embodiments pertain to a mobile telecommunications system base station comprising circuitry configured to: establish a radio bearer based on a signaling from a core network or based on assistance information from an application function, wherein the radio bearer meets a time-sensitive stream requirement, as discussed herein.

The base station may form a counter part to a user equipment (or terminal device) and may be, as the user equipment, part of a mobile telecommunications system. Accordingly, some embodiments pertain to a mobile telecommunications system including a base station and a user equipment according to the present disclosure.

In some embodiments, the base station and/or the circuitry is further configured to: receive, from a user equipment, a request for a time-sensitive stream based on at least one of an operation and maintenance tool, a service contract, and a predefined configuration of the user equipment, as discussed herein. In some embodiments, the base station fulfills a centralized user configuration function, as discussed herein. In some embodiments, the request based on the service contract is further based on information in at least one of a home subscriber server and a unified data management entity, as discussed herein. In some embodiments, the request is further based on at least one of capabilities of the user equipment and an expected service level, as discussed herein. In some embodiments, the predefined configuration is based on at least one of a SIM configuration and an application, as discussed herein. In some embodiments, the request indicates at least one time-sensitive stream requirement, as discussed herein. In some embodiments, the at least one time-sensitive stream requirement indicates at least one of a characteristic of the time-sensitive stream, a traffic quality of service, a system requirement, a capability of the user equipment, and a feature of the user equipment, as discussed herein. In some embodiments, the characteristic of the time-sensitive stream includes at least one of a type of the user equipment, a type of traffic, a purpose of the time-sensitive stream, and a type of a traffic pattern, as discussed herein. In some embodiments, the type of the user equipment includes at least one of a programmable logic controller, a pressure sensor, a human machine interface, and an emergency switch, as discussed herein. In some embodiments, at least one of the type of traffic and the purpose of the time-sensitive stream include at least one of safety communication, motion control, realtime data transfer, and non-realtime data transfer, as discussed herein. In some embodiments, the type of traffic pattern includes at least one of cyclic, periodic, aperiodic, synchronous, asynchronous, deterministic, and non-deterministic, as discussed herein. In some embodiments, the traffic quality of service includes at least one of a time-related requirement, a data rate requirement, a quality requirement, and monitoring requirement, as discussed herein. In some embodiments, the time-related requirement includes at least one of an end-to-end latency, a maximum allowed delay in worst case, time synchronicity, and cycle time, as discussed herein. In some embodiments, the data rate requirement includes at least one of a required bandwidth, a required communication rate, and a data rate, as discussed herein. In some embodiments, the quality requirement includes at least one of an error rate, a priority, and a service continuity, as discussed herein. In some embodiments, the monitoring requirement includes at least one of an error rate and a latency, as discussed herein. In some embodiments, the system requirement includes at least one of availability, security, a virtual isolation capability, as discussed herein. In some embodiments, at least one of the capability and the feature of the user equipment include at least one of supported band, supported frequency, RAT, non-RAT, 3GPP feature, non-public network support, public network support, mobility of the user equipment, supported positioning feature, power supply status, and authentication, as discussed herein. In some embodiments, the circuitry is further configured to: establish the time-sensitive stream in accordance with the request, as discussed herein. In some embodiments, the base station is part of an industrial 5G network, as discussed herein. In some embodiments, the industrial 5G network is provided in accordance with 3GPP IoT release 16 or later, as discussed herein. In some embodiments, time-sensitive stream corresponds to an internet of things data stream, as discussed herein.

Some embodiments pertain to a method carried out in a mobile telecommunications system base station, the method including: establishing a radio bearer based on a signaling from a core network or based on assistance information from an application function, wherein the radio bearer meets a time-sensitive stream requirement, as discussed herein.

In some embodiments, the method further includes: receiving, from a user equipment, a request for a time-sensitive stream based on at least one of an operation and maintenance tool, a service contract, and a predefined configuration of the user equipment, as discussed herein. In some embodiments, the base station fulfills a centralized user configuration function, as discussed herein. In some embodiments, the request based on the service contract is further based on information in at least one of a home subscriber server and a unified data management entity, as discussed herein. In some embodiments, the request is further based on at least one of capabilities of the user equipment and an expected service level, as discussed herein. In some embodiments, the predefined configuration is based on at least one of a SIM configuration and an application, as discussed herein. In some embodiments, the request indicates at least one time-sensitive stream requirement, as discussed herein. In some embodiments, the at least one time-sensitive stream requirement indicates at least one of a characteristic of the time-sensitive stream, a traffic quality of service, a system requirement, a capability of the user equipment, and a feature of the user equipment, as discussed herein. In some embodiments, the characteristic of the time-sensitive stream includes at least one of a type of the user equipment, a type of traffic, a purpose of the time-sensitive stream, and a type of a traffic pattern, as discussed herein. In some embodiments, the type of the user equipment includes at least one of a programmable logic controller, a pressure sensor, a human machine interface, and an emergency switch, as discussed herein. In some embodiments, at least one of the type of traffic and the purpose of the time-sensitive stream include at least one of safety communication, motion control, realtime data transfer, and non-realtime data transfer, as discussed herein. In some embodiments, the type of traffic pattern includes at least one of cyclic, periodic, aperiodic, synchronous, asynchronous, deterministic, and non-deterministic, as discussed herein. In some embodiments, the traffic quality of service includes at least one of a time-related requirement, a data rate requirement, a quality requirement, and monitoring requirement, as discussed herein. In some embodiments, the time-related requirement includes at least one of an end-to-end latency, a maximum allowed delay in worst case, time synchronicity, and cycle time, as discussed herein. In some embodiments, the data rate requirement includes at least one of a required bandwidth, a required communication rate, and a data rate, as discussed herein. In some embodiments, the quality requirement includes at least one of an error rate, a priority, and a service continuity, as discussed herein. In some embodiments, the monitoring requirement includes at least one of an error rate and a latency, as discussed herein. In some embodiments, the system requirement includes at least one of availability, security, a virtual isolation capability, as discussed herein. In some embodiments, at least one of the capability and the feature of the user equipment include at least one of supported band, supported frequency, RAT, non-RAT, 3GPP feature, non-public network support, public network support, mobility of the user equipment, supported positioning feature, power supply status, and authentication, as discussed herein. In some embodiments, the method further includes: establishing the time-sensitive stream in accordance with the request, as discussed herein. In some embodiments, the base station is part of an industrial 5G network, as discussed herein. In some embodiments, the industrial 5G network is provided in accordance with 3GPP IoT release 16 or later, as discussed herein. In some embodiments, time-sensitive stream corresponds to an internet of things data stream, as discussed herein.

As discussed above, the TSN configuration request may be sent, from the TSN-AF 13 to the 5G core network node 14. For the TSN stream, a QoS may be defined. Conventional 5G QoS characteristics may include (in accordance with 3GPP TS 23.501 V 17.5.0 (2022-06) resource type, priority level, packet delay budget, packet error rate, averaging window, maximum data burst volume, and the like.

Moreover, in the conventional 3GPP QoS definition when an application (e.g., Conversational Voice) requests the bearer with specific QoS class indicator (e.g., pre-defined QCI for Conversational Voice), the core network may configure the dedicated bearer to meet the QoS requirements based on the indicated QCI. In line with the dedicated bearer, the RAN may configure the data radio bearer with RRC connection reconfiguration. RAN allocates the radio resources to meet the QoS requirements. For example, semi-persistent scheduling may be applied for voice.

However, it has been recognized that safety communication may require a higher QoS.

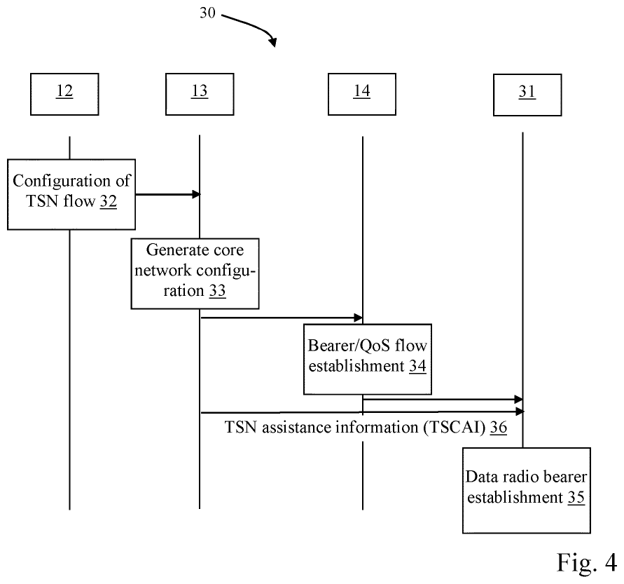

FIG. 4 depicts a method 30 which shows an information exchange between the TSN-AF 13 and the core network 14 and RAN network 31.

At 32, the CNC 12 generates the TSN configuration and sends it to the TSN-AF 13. The configuration includes topology, resources, and traffic scheduling.

At 33, the TSN-AF 13 sends the configuration stream to the core network (CN) 14, which includes, on the network side TSN translator (NW-TT), ingress/egress ports at UPF side, and on the device side TSN translator (DS-TT), ingress/egress ports at UE side. Moreover, the CN 14 configures the QoS flow, at 34, in response to the request from the TSN-AF 13. The QoS flow includes existing QCI and newly defined QCI.

At 35, the CN 14 requests to establish the radio bearers to the RAN 31 in line with the defined QoS flow. Moreover, at 36, the TSN-AF generates TSCAI (TSC assistance information) for the RAN 31 and sends it to the RAN 31.

The RAN 31 configures the radio bearer(s) and allocates the resources.

It has been recognized that there may be some challenges for IIoT use cases. There may be many IIoT use cases and various requirements compared to “normal” telecom operator's services (e.g., Voice, Packet, SMS and so on).

It has been recognized that these “normal” services may not cover the existing 3GPP standardized QoS table (5QI). Furthermore, the characteristic of IIoT traffic may not be in line with the conventional 3GPP QoS characteristics. Hence, it has been recognized that it is desirable to provide a new definition of QoS characteristics.

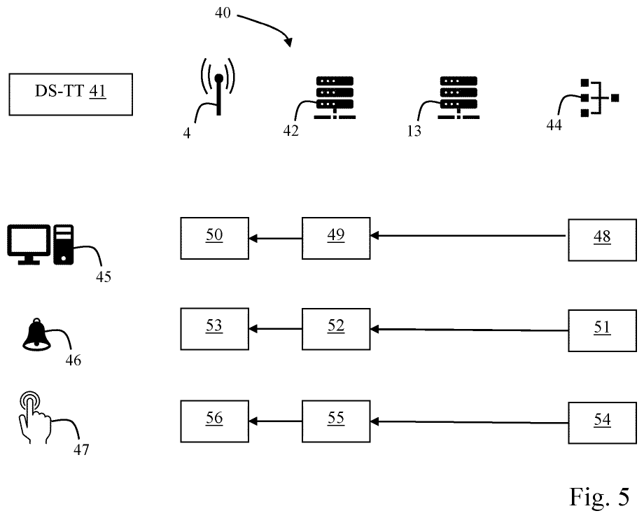

Traffic flow from external network may allocate one or more than one QoS Flow. The QoS flow may be mapped to one or more than one data radio bearer (DRB) with a Service Data Adaption Protocol (SDAP) at the gNB. More than one QoS flow may combine into one DRB if the QoS characteristic is similar. Mapping of QoS flows is discussed in the following, under reference of FIG. 5.

FIG. 5 depicts an IIoT system 40 according to the present disclosure. The system 40 includes a DS-TT 41, the gNB 4, a NW-TT (UPF) 42, the TSN-AF 13, an external (company/factory) network 44, and user equipments (UEs) 45, 46, and 47.

The external network 44 sends non-realtime traffic 48 to the UE 45. The non-realtime traffic 48 is converted to a first QoS flow 49 and is transmitted to the UE 45, as DRB1 50, via eMBB protocol.

In this example of the first QoS flow 49, the UE 45 is an industrial computer for production monitoring with non-realtime traffic. The UPF 42 establishes the first QoS flow 49 to the gNB 4 with a 5G QoS identifier being set to 10.

For communicating with the second UE 46, the external network uses alarms/events 51, via a second QoS flow 52, which is transmitted as DRB2 53, via URLLC protocol.

In one example of the second QoS flow 52 (non-urgent event monitoring), the UPF 42 established the QoS flow 55 to the gNB 4 with the 5G QoS identifier being set to 3 (process automation monitoring from standardized 5QI).

In another example of the second QoS flow 52 (alarm monitoring) the UPF 42 establishes the QoS flow 55 to the gNB 4 with the 5G QoS identifier being set to 3 (process automation monitoring, as above), but a high priority level is set for this QoS flow 52. If an alarm is detected, the gNB 4 is configured to interrupt other traffic to meet low latency requirements.

A safety communication 54 is established between the network 44 and the UE 47. Hence, a third QoS flow 55 is transmitted to the UE 47, as DRB3 56, via cyclic URLLC protocol.

In this example of the third QoS flow 55, an emergency stop of a machine is established for the UE 47. For such an emergency stop, immediate action may be required (i.e., stop the machine). In such a scenario, the safety communication must work even if other communication is interrupted. In this example, the UPF 42 establishes the QoS flow 55 (which is not defined in 3GPP yet).

It has been recognized that there may be two possibilities to handle such a scenario: define a new 5QI for such a safety communication scenario or using an existing 5QI definition and override is based on the TSCAI.

Hence, some embodiments pertain to a user equipment comprising circuitry configured to: carry out an emergency stop based on a quality of service flow, as discussed herein.

In some embodiments, the quality of service flow is based on a quality of service definition, as discussed herein.

In some embodiments, the quality of service definition is based on at least one of an application of the user equipment, a safety requirement, a communication type, a latency, a packet error rate, and a redundancy path requirement.

For example, deterministic communication, cyclic communication, or the like may be included. Moreover, a priority level may be taken into account for the application of the user equipment.

In some embodiments, the quality of service definition is based on RAN assistance information.

In some embodiments, the RAN assistance information is used to override an existing quality of service definition.

For example, if a QoS flow is established for discrete automation, but safety communication would fit better, the TSN-AF may be configured to provide TSCAI to the gNB to compensate missing QoS parameters for the specific application (e.g., safety).

Accordingly, the gNB may be configured to override a particular part of the 5QI with the TSCAI to meet the required QoS.

The TSCAI may newly be defined based on an application type (e.g., safety), severity (e.g., negative impact) if it is missed, fail safe communication, or the like.

Additionally or alternatively, existing TSCAI may be used, such as flow direction (uplink, downlink, bidirectional, or the like), periodicity, burst arrival time, survival time, or the like.

Hence, in some embodiments, the circuitry is further configured to: override the existing quality of service definition based on an application requirement of the user equipment (e.g., based on a command of the gNB).

In some embodiments, the user equipment is part of an industrial 5G network, as discussed herein.

In some embodiments, the industrial 5G network is provided in accordance with 3GPP IOT release 16 or later, as discussed herein.

Some embodiments pertain to a method carried out in a user equipment, the method including: carrying out an emergency stop based on a quality of service flow, as discussed herein. In some embodiments, the quality of service flow is based on a quality of service definition, as discussed herein. In some embodiments, the quality of service definition is based on at least one of an application of the user equipment, a safety requirement, a communication type, a latency, a packet error rate, and a redundancy path requirement, as discussed herein. In some embodiments, the quality of service definition is based on RAN assistance information, as discussed herein. In some embodiments, the RAN assistance information is used to override an existing quality of service definition, as discussed herein. In some embodiments, the method further includes overriding the existing quality of service definition based on an application requirement of the user equipment, as discussed herein. In some embodiments, the user equipment is part of an industrial 5G network, as discussed herein. In some embodiments, the industrial 5G network is provided in accordance with 3GPP IoT release 16 or later, as discussed herein.

Some embodiments pertain to a mobile telecommunications base station including circuitry configured to (and/or to a method carried out in a base station, the method including): provide a quality of service flow to a user equipment for surveilling functionality of the user equipment and, in case of the quality of service flow does not meet a requirement (and/or (if the flow is quantifiable and quantified) is below a predetermined threshold), for carrying out an emergency stop of the user equipment, as discussed herein.

In some embodiments, the quality of service flow is based on a quality of service definition, as discussed herein. In some embodiments, the quality of service definition is based on at least one of an application of the user equipment, a safety requirement, a communication type, a latency, a packet error rate, and a redundancy path requirement, as discussed herein. In some embodiments, the base station is part of a radio access network, RAN, and wherein quality of service definition is based on RAN assistance information, as discussed herein. In some embodiments, the RAN assistance information is used to override an existing quality of service definition, as discussed herein. In some embodiments, the circuitry is further configured to: override the existing quality of service definition based on an application requirement of the user equipment, as discussed herein. In some embodiments, the base station is part of an industrial 5G network, as discussed herein. In some embodiments, the industrial 5G network is provided in accordance with 3GPP IoT release 16 or later, as discussed herein.

In 3GPP Rel-17, the TSCAI is provided from TSN-AF to the RAN (gNB), which uses it for resource allocation, scheduling, and the like. It has been recognized that this may be effective, if the network is configured as static or semi-static. However, an unexpected (unplanned) status change may occur to the network.

Hence, it has been recognized that the TSCAI may be used for quickly reconfiguring a network in which such a status change has occurred since based on the TSCAI, the RAN may dynamically recognize a real-time UE status.

For example, in a chemical plant, the not so severe alarms/events may moderately be issued in normal operation and the network can handle them as usual. However, if the plant faces an incident or an emergency, a large number of alarms/events may occur at the same time, such a network capacity for such alarm streams should be expanded immediately in response to the incident.

For example, in a factory shop floor, a machine may generate a large electromagnetic noise during operation which may interfere with other radio devices. If the network “knows” the machine is about to start the operation (and thereby generate the noise), the network may reconfigure itself to be prepared for that situation. For example, in such a case, a frequency may be changed, resources may be reallocated, and the like.

For example, in a factory shop floor, a material handling vehicle/equipment may suddenly block a line of sight (LoS) from a base station antenna to a UE antenna. If the network “knows” the material handling vehicle arrives at the spot of a workstation and is likely to block the LoS, a necessary handover may be initiated in advance.

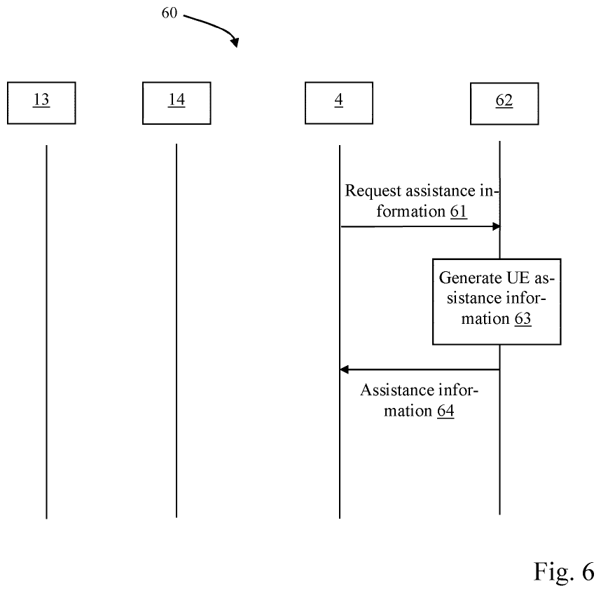

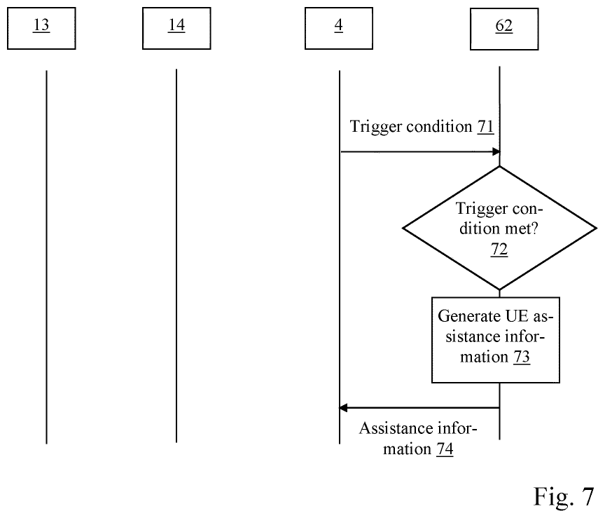

FIG. 6 depicts a method 60 according to the present disclosure for transmission of TSCAI.

In conventional TSCAI, it may be assumed that an environment of a network is static. Therefore, when the network starts the TSC communication, the network is configured based on initial information and maintain the same network configuration during the TSC communication.

However, the environment of network may change, e.g., if the UE is moving. Also, the traffic may change, a status of production may change, and so on. Therefore, it may be desirable that the network knows the change of the UE environment such that the network can adjust to the change. The UE may know its environment, such that it has been recognized that the UE may report the change to the network.

The RAN (gNB) 4 requests, at 61, the TSCAI from a UE 62. For example, the RAN 4 would like to lower a service level (e.g., lower resolution of video streaming) due to other traffic increase, such that the network would like to know its impact at UE side.

Hence, at 63, the UE 62 generates the TSCAI in response to the request and sends the TSCAI, at 64, to the RAN 4.

Hence, the RAN 4 may reconfigure the data radio bearer based on the transmitted TSCAI.

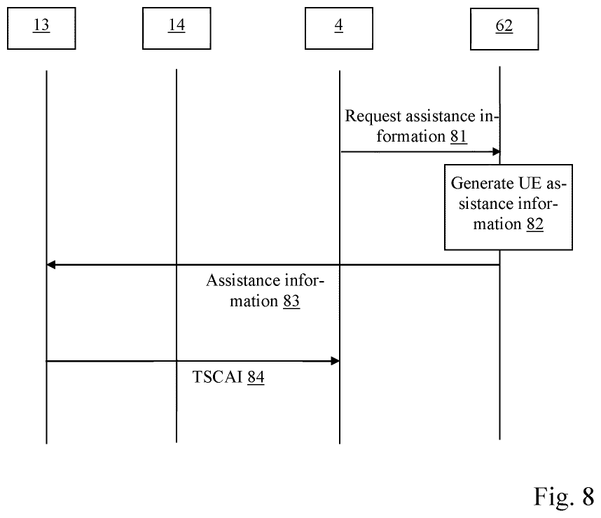

However, in some embodiments, the TSCAI may only be generated and transmitted to the RAN 4, when a trigger condition is met, as discussed in the following, under reference of FIG. 7.

FIG. 7 depicts a further method 70 according to the present disclosure for transmission of TSCAI.

At 71, the RAN 4 sends the trigger condition of the TSCAI to the UE 62. For example, the trigger condition is that the RAN 4 would like to know that UE (e.g. automatic guided vehicle) reaches the spot at which a machine unloads parts. Another example of trigger condition may be a detection of an emergency situation at the UE. In that case, a flooding of traffic with alarms/events may be expected. Such an impact may need to be braced by the network. In some embodiments, the trigger condition may be predefined, such that the UE 64 recognizes the trigger condition without signaling from the RAN 4. For example, in case of emergency, the assistance information should be reported as soon as possible. The UE may skip a normal procedure of trigger judgement and immediately report the emergency status.

At 72, the UE 62 decides whether the trigger condition is met, such that the TSCAI is generated, at 73, and, at 74, sent to the RAN 4.

FIG. 8 depicts a further embodiment of a method 80 for the transmission of TSCAI.

At 81, the RAN 4 requests assistance information from the UE 62. The UE 61 generates the TSCAI at 82 but sends it to the TSN-AF 13 (via the core network 14).

At 84, the TSN-AF 13 sends the TSCAI to the RAN 4.

In such an embodiment, the TSN-AF 13 may understand the status of the UE 62 and may thus select or determine information which is suitable for the RAN 4.

Accordingly, some embodiments pertain to a user equipment including circuitry configured to: receive a request for assistance information; and send the assistance information when a trigger condition is met, as discussed herein.

In some embodiments, the request for assistance information is received from a base station, as discussed herein. In some embodiments, the assistance information is sent to the base station and to an application function, as discussed herein. In some embodiments, the user equipment is part of an industrial 5G network, as discussed herein. In some embodiments, the industrial 5G network is provided in accordance with 3GPP IoT release 16 or later, as discussed herein.

Some embodiments pertain to a method carried out in a user equipment, the method including: receiving a request for assistance information; and sending the assistance information when a trigger condition is met, as discussed herein.

In some embodiments, the request for assistance information is received from a base station, as discussed herein. In some embodiments, the assistance information is sent to at least one of the base station and an application function, as discussed herein. In some embodiments, the user equipment is part of an industrial 5G network, as discussed herein. In some embodiments, the industrial 5G network is provided in accordance with 3GPP IoT release 16 or later, as discussed herein.

Some embodiments pertain to a mobile telecommunications base station including circuitry configured to: request, to a user equipment, assistance information which is provided to the base station when a trigger condition is met, as discussed herein.

In some embodiments, the assistance information is further received by an application function, as discussed herein. In some embodiments, the base station is part of an industrial 5G network, as discussed herein. In some embodiments, the industrial 5G network is provided in accordance with 3GPP IoT release 16 or later.

Some embodiments pertain to a method carried out in a mobile telecommunications base station, the method including: requesting, to a user equipment, assistance information which is provided to the base station when a trigger condition is met, as discussed herein.

In some embodiments, the assistance information is further received by an application function,, as discussed herein. In some embodiments, the base station is part of an industrial 5G network, as discussed herein. In some embodiments, the industrial 5G network is provided in accordance with 3GPP IoT release 16 or later, as discussed herein.

Some embodiments pertain to a communication network node including circuitry configured to: obtain time-sensitive communication assistance information, TSCAI, from a user equipment, wherein the TSCAI is generated by the user equipment in response to a request of a mobile telecommunication base station, as discussed herein.

In some embodiments, the user equipment sends the TSCAI in response to a request of a mobile telecommunication base station.

In some embodiments, the user equipment autonomously sends the TSCAI without a request of a mobile telecommunication base station.

In some embodiments, the circuitry is further configured to: select, based on the TSCAI, suitable information, which is suitable for the base station; and send the suitable information to the base station, as discussed herein. In some embodiments, wherein the communication network node includes a time-sensitive network application function, as discussed herein. In some embodiments, the network node is part of an industrial 5G network, as discussed herein. In some embodiments, the industrial 5G network is provided in accordance with 3GPP IoT release 16 or later.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) A user equipment comprising circuitry configured to:
establish a radio bearer based on a signaling from a core network or based on assistance information from an application function, wherein the radio bearer meets a time-sensitive stream requirement.
(2) The user equipment of (1), wherein the circuitry is further configured to:
request a time-sensitive stream based on at least one of an operation and maintenance tool, a service contract, and a predefined configuration of the user equipment.
(3) The user equipment of (2), wherein the request based on the service contract is further based on information in at least one of a home subscriber server, a unified data management entity capabilities of the user equipment, and an expected service level.
(4) The user equipment of anyone of (2) or (3), wherein the predefined configuration is based on at least one of a SIM configuration and an application.
(5) The user equipment of anyone of (2) to (4), wherein the request indicates at least one time-sensitive stream requirement.
(6) The user equipment of (5), wherein the at least one time-sensitive stream requirement indicates at least one of a characteristic of the time-sensitive stream, a traffic quality of service, a system requirement, a capability of the user equipment, and a feature of the user equipment.
(7) The user equipment of (6), wherein the characteristic of the time-sensitive stream includes at least one of a type of the user equipment, a type of traffic, a purpose of the time-sensitive stream, and a type of a traffic pattern.
(8) The user equipment of (7), wherein the type of the user equipment includes at least one of a programmable logic controller, a pressure sensor, a human machine interface, and an emergency switch.
(9) The user equipment of (7) or (8), wherein at least one of the type of traffic and the purpose of the time-sensitive stream include at least one of safety communication, motion control, realtime data transfer, and non-realtime data transfer.
(10) The user equipment of anyone of (7) to (9), wherein the type of traffic pattern includes at least one of cyclic, periodic, aperiodic, synchronous, asynchronous, deterministic, and non-deterministic.
(11) The user equipment of anyone of (6) to (10), wherein the traffic quality of service includes at least one of a time-related requirement, a data rate requirement, a quality requirement, and monitoring requirement.
(12) The user equipment of (11), wherein the time-related requirement includes at least one of an end-to-end latency, a maximum allowed delay in worst case, time synchronicity, and cycle time.
(13) The user equipment of (11) or (12), wherein the data rate requirement includes at least one of a required bandwidth, a required communication rate, and a data rate.
(14) The user equipment of anyone of (11) to (13), wherein the quality requirement includes at least one of an error rate, a priority, and a service continuity.
(15) The user equipment of anyone of (11) to (14), wherein the monitoring requirement includes at least one of an error rate and a latency.
(16) The user equipment of anyone of (6) to (15), wherein the system requirement includes at least one of availability, security, a virtual isolation capability.
(17) The user equipment of anyone of (6) to (16), wherein at least one of the capability and the feature of the user equipment include at least one of supported band, supported frequency, RAT, non-RAT, 3GPP feature, non-public network support, public network support, mobility of the user equipment, supported positioning feature, power supply status, and authentication.
(18) The user equipment of anyone of (1) to (17), wherein the circuitry is further configured to:
communicate with a centralized user configuration entity.
(19) The user equipment of (18), wherein the circuitry is further configured to:
send, to the centralized user configuration entity, at least one of characteristics of the time-sensitive stream, system requirements, and a capability of the user equipment.
(20) The user equipment of anyone of (1) to (19), wherein the user equipment is part of an industrial 5G network.
(21) The user equipment (20), wherein the industrial 5G network is provided in accordance with 3GPP IoT release 16 or later.
(22) The user equipment of anyone of (1) to (21), wherein time-sensitive stream corresponds to an internet of things data stream.
(23) A method carried out in a user equipment, the method comprising:
establishing a radio bearer based on a signaling from a core network or based on assistance information from an application function, wherein the radio bearer meets a time-sensitive stream requirement.
(24) The method of (23), further comprising:
requesting a time-sensitive stream based on at least one of an operation and maintenance tool, a service contract, and a predefined configuration of the user equipment.
(25) The method of (24), wherein the request based on the service contract is further based on information in at least one of a home subscriber server, a unified data management entity capabilities of the user equipment, and an expected service level.
(26) The method of (24) or (25), wherein the predefined configuration is based on at least one of a SIM configuration and an application.
(27) The method of anyone of (24) to (26), wherein the request indicates at least one time-sensitive stream requirement.
(28) The method of (27), wherein the at least one time-sensitive stream requirement indicates at least one of a characteristic of the time-sensitive stream, a traffic quality of service, a system requirement, a capability of the user equipment, and a feature of the user equipment.
(29) The method of (28), wherein the characteristic of the time-sensitive stream includes at least one of a type of the user equipment, a type of traffic, a purpose of the time-sensitive stream, and a type of a traffic pattern.
(30) The method of (29), wherein the type of the user equipment includes at least one of a programmable logic controller, a pressure sensor, a human machine interface, and an emergency switch.
(31) The method of (29) or (30), wherein at least one of the type of traffic and the purpose of the time-sensitive stream include at least one of safety communication, motion control, realtime data transfer, and non-realtime data transfer.
(32) The method of anyone of (29) to (31), wherein the type of traffic pattern includes at least one of cyclic, periodic, aperiodic, synchronous, asynchronous, deterministic, and non-deterministic.
(33) The method of anyone of (28) to (32), wherein the traffic quality of service includes at least one of a time-related requirement, a data rate requirement, a quality requirement, and monitoring requirement.
(34) The method of (33), wherein the time-related requirement includes at least one of an end-to-end latency, a maximum allowed delay in worst case, time synchronicity, and cycle time.
(35) The method of (33) or (34), wherein the data rate requirement includes at least one of a required bandwidth, a required communication rate, and a data rate.
(36) The method of anyone of (33) to (35), wherein the quality requirement includes at least one of an error rate, a priority, and a service continuity.
(37) The method of anyone of (33) to (36), wherein the monitoring requirement includes at least one of an error rate and a latency.
(38) The method of anyone of (28) to (37), wherein the system requirement includes at least one of availability, security, a virtual isolation capability.
(39) The method of anyone of (28) to (38), wherein at least one of the capability and the feature of the user equipment include at least one of supported band, supported frequency, RAT, non-RAT, 3GPP feature, non-public network support, public network support, mobility of the user equipment, supported positioning feature, power supply status, and authentication.
(40) The method of anyone of (23) to (39), further comprising:
communicating with a centralized user configuration entity.
(41) The method of (40), further comprising:
sending, to the centralized user configuration entity, at least one of characteristics of the time-sensitive stream, system requirements, and a capability of the user equipment.
(42) The method of anyone of (23) to (41), wherein the user equipment is part of an industrial 5G network.
(43) The method of (42), wherein the industrial 5G network is provided in accordance with 3GPP IoT release 16 or later.
(44) The method of anyone of (23) to (43), wherein time-sensitive stream corresponds to an internet of things data stream.
(45) A mobile telecommunications system base station comprising circuitry configured to:
establish a radio bearer based on a signaling from a core network or based on assistance information from an application function, wherein the radio bearer meets a time-sensitive stream requirement.
(46) The base station of (45), further configured to:
receive, from a user equipment, a request for a time-sensitive stream based on at least one of an operation and maintenance tool, a service contract, and a predefined configuration of the user equipment.
(47) The base station of (45), wherein the base station fulfills a centralized user configuration function.
(48) The base station of (46) or (47), wherein the request based on the service contract is further based on information in at least one of a home subscriber server, a unified data management entity capabilities of the user equipment, and an expected service level.
(49) The base station of anyone of (46) to (48), wherein the predefined configuration is based on at least one of a SIM configuration and an application.
(50) The base station of anyone of (46) to (49), wherein the request indicates at least one time-sensitive stream requirement.
(51) The base station of (50), wherein the at least one time-sensitive stream requirement indicates at least one of a characteristic of the time-sensitive stream, a traffic quality of service, a system requirement, a capability of the user equipment, and a feature of the user equipment.
(52) The base station of (51), wherein the characteristic of the time-sensitive stream includes at least one of a type of the user equipment, a type of traffic, a purpose of the time-sensitive stream, and a type of a traffic pattern.
(53) The base station of (52), wherein the type of the user equipment includes at least one of a programmable logic controller, a pressure sensor, a human machine interface, and an emergency switch.
(54) The base station of (52) or (53), wherein at least one of the type of traffic and the purpose of the time-sensitive stream include at least one of safety communication, motion control, realtime data transfer, and non-realtime data transfer.
(55) The base station of anyone of (52) to (54), wherein the type of traffic pattern includes at least one of cyclic, periodic, aperiodic, synchronous, asynchronous, deterministic, and non-deterministic.
(56) The base station of anyone of (51) to (55), wherein the traffic quality of service includes at least one of a time-related requirement, a data rate requirement, a quality requirement, and monitoring requirement.
(57) The base station of (56), wherein the time-related requirement includes at least one of an end-to-end latency, a maximum allowed delay in worst case, time synchronicity, and cycle time.
(58) The base station of (56) or (57), wherein the data rate requirement includes at least one of a required bandwidth, a required communication rate, and a data rate.
(59) The base station of anyone of (56) to (58), wherein the quality requirement includes at least one of an error rate, a priority, and a service continuity.
(60) The base station of anyone of (56) to (59), wherein the monitoring requirement includes at least one of an error rate and a latency.
(61) The base station of anyone of (51) to (60), wherein the system requirement includes at least one of availability, security, an virtual isolation capability.
(62) The base station of anyone of (51) to (61), wherein at least one of the capability and the feature of the user equipment include at least one of supported band, supported frequency, RAT, non-RAT, 3GPP feature, non-public network support, public network support, mobility of the user equipment, supported positioning feature, power supply status, and authentication.
(63) The base station of anyone of (46) to (62), wherein the circuitry is further configured to:
establish the time-sensitive stream in accordance with the request.
(64) The base station of anyone of (45) to (63), wherein the base station is part of an industrial 5G network.
(65) The base station of (64), wherein the industrial 5G network is provided in accordance with 3GPP IoT release 16 or later.
(66) The base station of anyone of (45) to (65), wherein time-sensitive stream corresponds to an internet of things data stream.
(67) A method carried out in a mobile telecommunications system base station, the method comprising:
establishing a radio bearer based on a signaling from a core network or based on assistance information from an application function, wherein the radio bearer meets a time-sensitive stream requirement.
(68) The method of (67), further comprising:
receiving, from a user equipment, a request for a time-sensitive stream based on at least one of an operation and maintenance tool, a service contract, and a predefined configuration of the user equipment.
(69) The method of (67) or (68), wherein the base station fulfills a centralized user configuration function.
(70) The method of (68) or (69), wherein the request based on the service contract is further based on information in at least one of a home subscriber server and a unified data management entity.
(71) The method of (70), wherein the request is further based on at least one of capabilities of the user equipment and an expected service level.
(72) The method of anyone of (68) to (71), wherein the request indicates at least one time-sensitive stream requirement.
(73) The method of (72), wherein the at least one time-sensitive stream requirement indicates at least one of a characteristic of the time-sensitive stream, a traffic quality of service, a system requirement, a capability of the user equipment, and a feature of the user equipment.
(74) The method of (73), wherein the characteristic of the time-sensitive stream includes at least one of a type of the user equipment, a type of traffic, a purpose of the time-sensitive stream, and a type of a traffic pattern.
(75) The method of (74), wherein the type of the user equipment includes at least one of a programmable logic controller, a pressure sensor, a human machine interface, and an emergency switch.
(76) The method of (74) or (75), wherein at least one of the type of traffic and the purpose of the time-sensitive stream include at least one of safety communication, motion control, realtime data transfer, and non-realtime data transfer.
(77) The method of anyone of (74) to (76), wherein the type of traffic pattern includes at least one of cyclic, periodic, aperiodic, synchronous, asynchronous, deterministic, and non-deterministic.
(78) The method of anyone of (73) to (77), wherein the traffic quality of service includes at least one of a time-related requirement, a data rate requirement, a quality requirement, and monitoring requirement.
(79) The method of (78), wherein the time-related requirement includes at least one of an end-to-end latency, a maximum allowed delay in worst case, time synchronicity, and cycle time.
(80) The method of (78) or (79), wherein the data rate requirement includes at least one of a required bandwidth, a required communication rate, and a data rate.
(81) The method of anyone of (78) to (80), wherein the quality requirement includes at least one of an error rate, a priority, and a service continuity.
(82) The method of anyone of (78) to (81), wherein the monitoring requirement includes at least one of an error rate and a latency.
(83) The method of anyone of (73) to (82), wherein the system requirement includes at least one of availability, security, an virtual isolation capability.
(84) The method of anyone of (73) to (83), wherein at least one of the capability and the feature of the user equipment include at least one of supported band, supported frequency, RAT, non-RAT, 3GPP feature, non-public network support, public network support, mobility of the user equipment, supported positioning feature, power supply status, and authentication.
(85) The method of anyone of (67) to (84), further comprising:
establishing the time-sensitive stream in accordance with the request.
(86) The method of anyone of (67) to (85), wherein the base station is part of an industrial 5G network.
(87) The method of (86), wherein the industrial 5G network is provided in accordance with 3GPP IoT release 16 or later.
(88) The method of anyone of (67) to (87), wherein time-sensitive stream corresponds to an internet of things data stream.
(89) A user equipment comprising circuitry configured to:
carry out an emergency stop based on a quality of service flow.
(90) The user equipment of (89), wherein the quality of service flow is based on a quality of service definition.
(91) The user equipment of (90), wherein the quality of service definition is based on at least one of an application of the user equipment, a safety requirement, a communication type, a latency, a packet error rate, and a redundancy path requirement.
(92) The user equipment of (90) or (91), wherein the quality of service definition is based on RAN assistance information.
(93) The user equipment (92), wherein the RAN assistance information is used to override an existing quality of service definition.
(94) The user equipment of (93), wherein the circuitry is further configured to:
override the existing quality of service definition based on an application requirement of the user equipment.
(95) The user equipment of anyone of (89) to (94), wherein the user equipment is part of an industrial 5G network.
(96) The user equipment anyone of (89) to (95), wherein the industrial 5G network is provided in accordance with 3GPP IoT release 16 or later.
(97) A method carried out in a user equipment, the method comprising:
carrying out an emergency stop based on a quality of service flow.
(98) The method of (97), wherein the quality of service flow is based on a quality of service definition.
(99) The method of (98), wherein the quality of service definition is based on at least one of an application of the user equipment, a safety requirement, a communication type, a latency, a packet error rate, and a redundancy path requirement.
(100) The method of (98) or (99), wherein the quality of service definition is based on RAN assistance information.
(101) The method of (100), wherein the RAN assistance information is used to override an existing quality of service definition.
(102) The method of (101), further comprising:
overriding the existing quality of service definition based on an application requirement of the user equipment.
(103) The method of anyone of (97) to (102), wherein the user equipment is part of an industrial 5G network.
(104) The method of anyone of (97) to (103), wherein the industrial 5G network is provided in accordance with 3GPP IoT release 16 or later.
(105) A mobile telecommunications base station comprising circuitry configured to:
provide a quality of service flow to a user equipment for surveilling functionality of the user equipment and, in case of the quality of service flow does not meet a requirement, for carrying out an emergency stop of the user equipment.
(106) The base station of (105), wherein the quality of service flow is based on a quality of service definition.
(107) The base station of (106), wherein the quality of service definition is based on at least one of an application of the user equipment, a safety requirement, a communication type, a latency, a packet error rate, and a redundancy path requirement.
(108) The base station of (106) or (107), wherein the base station is part of a radio access network, RAN, and wherein quality of service definition is based on RAN assistance information.
(109) The base station of (108), wherein the RAN assistance information is used to override an existing quality of service definition.
(110) The base station of (109), wherein the circuitry is further configured to:
override the existing quality of service definition based on an application requirement of the user equipment.
(111) The base station of anyone of (105) to (110), wherein the base station is part of an industrial 5G network.
(112) The base station of (111), wherein the industrial 5G network is provided in accordance with 3GPP IoT release 16 or later.
(113) A method carried out in a mobile telecommunications base station, the method comprising:
providing a quality of service flow to a user equipment for surveilling functionality of the user equipment and, in case of the quality of service flow does not meet a requirement, for carrying out an emergency stop of the user equipment.
(114) The method of (113), wherein the quality of service flow is based on a quality of service definition.
(115) The method of (114), wherein the quality of service definition is based on at least one of an application of the user equipment, a safety requirement, a communication type, a latency, a packet error rate, and a redundancy path requirement.
(116) The method of (114) or (115), wherein the base station is part of a radio access network, RAN, and wherein quality of service definition is based on RAN assistance information.
(117) The method of (116), wherein the RAN assistance information is used to override an existing quality of service definition.
(118) The method of (117), further comprising:
overriding the existing quality of service definition based on an application requirement of the user equipment.
(119) The method of anyone of (113) to (118), wherein the base station is part of an industrial 5G network.
(120) The method of (119), wherein the industrial 5G network is provided in accordance with 3GPP IoT release 16 or later.
(121) A user equipment comprising circuitry configured to:
receive a request for assistance information; and
send the assistance information when a trigger condition is met.
(122) The user equipment of (121), wherein the request for assistance information is received from a base station.
(123) The user equipment of (122), wherein the assistance information is sent to the base station and to an application function.
(124) The user equipment of anyone of (121) to (123), wherein the user equipment is part of an industrial 5G network.
(125) The user equipment of anyone of (121) to (124), wherein the industrial 5G network is provided in accordance with 3GPP IoT release 16 or later.
(126) A method carried out in a user equipment, the method comprising:
receiving a request for assistance information; and
sending the assistance information when a trigger condition is met.
(127) The method of (126), wherein the request for assistance information is received from a base station.
(128) The method of (127), wherein the assistance information is sent to at least one of the base station and an application function.
(129) The method of anyone of (126) to (128), wherein the user equipment is part of an industrial 5G network.
(130) The method of anyone of (126) to (129), wherein the industrial 5G network is provided in accordance with 3GPP IoT release 16 or later.
(131) A mobile telecommunications base station comprising circuitry configured to:
request, to a user equipment, assistance information which is provided to the base station when a trigger condition is met.
(132) The base station of (131), wherein the assistance information is further received by an application function.
(133) The base station of (131) or (132), wherein the base station is part of an industrial 5G network.
(134) The method of (133), wherein the industrial 5G network is provided in accordance with 3GPP IoT release 16 or later.
(135) A method carried out in a mobile telecommunications base station, the method comprising:
requesting, to a user equipment, assistance information which is provided to the base station when a trigger condition is met.
(136) The method of (135), wherein the assistance information is further received by an application function.
(137) The method of (135) or (136), wherein the base station is part of an industrial 5G network.
(138) The method of (137), wherein the industrial 5G network is provided in accordance with 3GPP IoT release 16 or later.
(139) A communication network node comprising circuitry configured to:
obtain time-sensitive communication assistance information, TSCAI, from a user equipment, wherein the TSCAI is generated by the user equipment.
(140) The communication network node of (139), wherein the user equipment sends the TSCAI in response to a request of a mobile telecommunication base station.
(141) The communication network node of (139) or (140), wherein the user equipment autonomously sends the TSCAI without a request of a mobile telecommunication base station.
(142) The communication network node of anyone of (139) to (141), wherein the circuitry is further configured to:
select, based on the TSCAI, suitable information, which is suitable for the base station; and
send the suitable information to the base station.
(143) The communication network node of anyone of (139) to (142), wherein the communication network node includes a time-sensitive network application function.
(144) A computer program comprising program code causing a computer to perform at least one of the methods according to anyone of (1) to (143), when being carried out on a computer.
(145) A non-transitory computer-readable recording medium that stores therein a computer program product, which, when executed by a processor, causes at least one of the methods according to anyone of (1) to (143) to be performed.

### References

[1] https://www.cisco.com/c/dam/en/us/solutions/collateral/industry-solutions/white-paper-c11-738950.pdf
[2] https://5g-acia.org/wp-content/uploads/2021/04/5G-ACIA_Integration-of-Industrial-Ethernet-Networks-with-5G-Networks-.pdf

1. A user equipment comprising circuitry configured to:
establish a radio bearer based on a signaling from a core network or based on assistance information from an application function, wherein the radio bearer meets a time-sensitive stream requirement.

2. The terminal device of claim 1, further configured to:
request the time-sensitive stream based on at least one of an operation and maintenance tool, a service contract, and a predefined configuration of the user equipment.

3. The user equipment of claim 2, wherein the request based on the service contract is further based on information in at least one of a home subscriber server, a unified data management entity, capabilities of the user equipment, and an expected service level.

4. The user equipment of claim 2, wherein the predefined configuration is based on at least one of a SIM configuration and an application.

5. The user equipment of claim 2, wherein the request indicates at least one time-sensitive stream requirement.

6. The user equipment of claim 5, wherein the at least one time-sensitive stream requirement indicates at least one of a characteristic of the time-sensitive stream, a traffic quality of service, a system requirement, a capability of the user equipment, and a feature of the user equipment.

7. The user equipment of claim 6, wherein the characteristic of the time-sensitive stream includes at least one of a type of the user equipment, a type of traffic, a purpose of the time-sensitive stream, and a type of a traffic pattern.

8. The user equipment of claim 7, wherein the type of the user equipment includes at least one of a programmable logic controller, a pressure sensor, a human machine interface, and an emergency switch.

9. The user equipment of claim 7, wherein at least one of the type of traffic and the purpose of the time-sensitive stream include at least one of safety communication, motion control, realtime data transfer, and non-realtime data transfer.

10. The user equipment of claim 7, wherein the type of traffic pattern includes at least one of cyclic, periodic, aperiodic, synchronous, asynchronous, deterministic, and non-deterministic.

11. The user equipment of claim 6, wherein the traffic quality of service includes at least one of a time-related requirement, a data rate requirement, a quality requirement, and monitoring requirement.

12. The user equipment of claim 11, wherein the time-related requirement includes at least one of an end-to-end latency, a maximum allowed delay in worst case, time synchronicity, and cycle time.

13. The user equipment of claim 11, wherein the data rate requirement includes at least one of a required bandwidth, a required communication rate, and a data rate.

14. The user equipment of claim 11, wherein the quality requirement includes at least one of an error rate, a priority, and a service continuity.

15. The user equipment of claim 11, wherein the monitoring requirement includes at least one of an error rate and a latency.

16. The user equipment of claim 6, wherein the system requirement includes at least one of availability, security, a virtual isolation capability.

17. The user equipment of claim 6, wherein at least one of the capability and the feature of the user equipment include at least one of supported band, supported frequency, RAT, non-RAT, 3GPP feature, non-public network support, public network support, mobility of the user equipment, supported positioning feature, power supply status, and authentication.

18. The user equipment of claim 1, wherein the circuitry is further configured to:
communicate with a centralized user configuration entity.

19.-104. (canceled)

105. A mobile telecommunications base station comprising circuitry configured to:
provide a quality of service flow to a user equipment for surveilling functionality of the user equipment and, in case of the quality of service flow does not meet a requirement, for carrying out an emergency stop of the user equipment.

106.-120. (canceled)

121. A user equipment comprising circuitry configured to:
receive a request for assistance information; and
send the assistance information when a trigger condition is met.

122.-143. (canceled)
